(19) United States
(12) Patent Application Publication
(10) Pub. No.: US 2026/0125131 A1
(43) Pub. Date: May 7, 2026

(54) Techniques For Displaying Wind Metrics To A Bike Rider

(71) Applicant: Wahoo Fitness L.L.C., Atlanta, GA (US)

(72) Inventors: Mark SNATERSE, Leiden (NL); Kilian Hendrickx, Wilrijk (BE)

(73) Assignee: Wahoo Fitness L.L.C., Atlanta, GA (US)

(21) Appl. No.: 19/378,568

(22) Filed: Nov. 4, 2025

Related U.S. Application Data
(60) Provisional application No. 63/716,959, filed on Nov. 6, 2024.

(51) Int. Cl. B62J 50/22; B62J 45/20; B62J 45/412

(52) U.S. Cl. CPC B62J 50/22; B62J 45/20; B62J 45/412

(57) ABSTRACT

A method is presented for displaying wind metrics to a rider of a bicycle. The method includes: measuring air speed relative to the rider of the bicycle, where the wind sensor is attached to the bicycle; determining speed of the bicycle relative to the ground, where the wind sensor is in data communication with the computer processor; computing effective air speed experienced by the rider by subtracting the speed of the bicycle from the air speed; and presenting the effective air speed on a display device to the rider, where the effective air speed includes an indicia of whether the air is assisting or hindering the motion of the bicycle. In one implementation, the effective air speed is a numeric value and color of the numeric value is the indicia of whether the air is assisting or hindering the motion of the bicycle.

### CROSS-REFERENCE TO RELATED APPLICATIONS

This application claims the benefit and priority of U.S. Provisional Application No. 63/716,959 filed on Nov. 6, 2024. The entire disclosure of the above application is incorporated herein by reference.

### FIELD

The present disclosure relates to techniques for displaying wind metrics to a bicycle rider.

### BACKGROUND

Bike computers are small devices configured to be attached to handlebars or another portion of a bicycle. Bike computers function to calculate and display various information about a ride to the rider of the bicycle. Information may include but is not limited to speed, cadence, power, distance, elevation profiles, etc. To calculate this information, the bike computer may be interfaced with and receive input from different types of sensors. Wind speed and how the wind is affecting the ride is one area that riders are keenly interested in. Therefore, it is desirable to develop improved techniques for determining and displaying wind metrics to the rider of a bicycle.

This section provides background information related to the present disclosure which is not necessarily prior art.

### SUMMARY

This section provides a general summary of the disclosure, and is not a comprehensive disclosure of its full scope or all of its features.

A method is presented for displaying wind metrics to a rider of a bicycle. The method includes: measuring air speed relative to the rider of the bicycle, where the wind sensor is attached to the bicycle; determining speed of the bicycle relative to the ground, where the wind sensor is in data communication with the computer processor; computing effective air speed experienced by the rider by subtracting the speed of the bicycle from the air speed; and presenting the effective air speed on a display device to the rider, where the effective air speed includes an indicia of whether the air is assisting or hindering the motion of the bicycle. In one embodiment, the effective air speed is a numeric value and color of the numeric value is the indicia of whether the air is assisting or hindering the motion of the bicycle.

In one embodiment, the effective air speed is a numeric value and color of the numeric value is the indicia of whether the air is assisting or hindering the motion of the bicycle. For example, the number value for the effective air speed may be displayed in green to indicate a tail wind and displayed in red to indicate a head wind. In some embodiments, the effective air speed displayed on the display device is dynamically updated while the bicycle is moving.

The speed of the bicycle may be determined using a speed sensor configured to measure rotational speed of a wheel of the bicycle. Alternatively, the speed of the bicycle is determined using input from a GPS module interfaced with the computer processor.

In another aspect, a non-transitory computer-readable medium having computer-executable instructions that, upon execution of the instructions by a processor of a bike computer, cause the bike computer to: receive, from a wind sensor, air speed relative to the rider of the bicycle, where the wind sensor is attached to a bicycle; determine speed of the bicycle relative to the ground; compute effective air speed experienced by the rider by subtracting the speed of the bicycle from the air speed; and present the effective air speed on a display device, where the effective air speed includes an indicia of whether the air is assisting or hindering the motion of the bicycle.

In yet another aspect, a system is provided for displaying wind metrics to a rider of a bicycle. The system is comprised of a wind sensor, a bike computer, and a display device. The wind sensor is attached to the bicycle and configured to measure air speed relative to the rider of the bicycle. The bike computer is in data communication with the wind sensor. The bike computer operates to determine speed of the bicycle relative to the ground and computer an effective air speed experienced by the rider by subtracting the speed of the bicycle from the air speed. The display device is interfaced with the bike computer and configured to present the effective air speed to the rider, where the effective air speed includes an indicia of whether the air is assisting or hindering the motion of the bicycle.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a diagram of a bicycle with a bike computer.

FIG. 2 is a block diagram of an example implementation of a bike computer.

FIG. 3 is a flowchart showing an improved technique for displaying effective wind speed to a rider.

FIG. 4 illustrates an example user interface for a bike computer.

FIG. 5 illustrates another example user interface on a bike computer.

FIG. 6 illustrates an example graphical user interface for displaying a grade/wind power ratio.

Corresponding reference numerals indicate corresponding parts throughout the several views of the drawings.

### DETAILED DESCRIPTION

Example embodiments will now be described more fully with reference to the accompanying drawings.

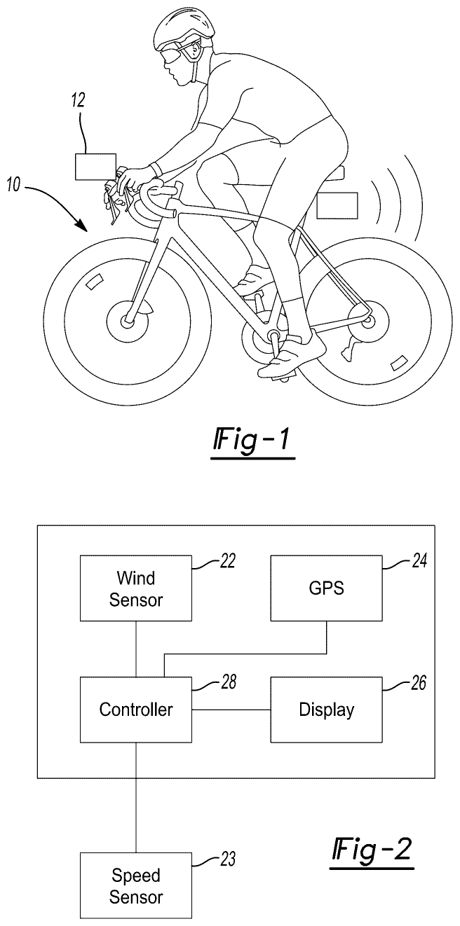

FIG. 1 depicts an example bicycle 10 with a bike computer 12 attached to the handlebars. ELEMNT bike computer commercially available from Wahoo Fitness is an example of a bike computer 12 although other types of bike computers are suitable as well. It is envisioned that the techniques described herein may be integrated into such bike computers. It is also envisioned that the bike computer 12 may be interfaced with external sensor devices (not shown) including but not limited to a wind sensor and/or a speed sensor.

FIG. 2 further depicts an example implementation of the bike computer 12. The bike computer 12 is comprised of an integrated wind sensor 22, a display 26 and a controller 28. In some embodiments, the bike computer 12 includes a global positioning system (GPS) module 24 as well as other sensors, such as a barometer. It is to be understood that only the relevant components of the bike computer are discussed in relation to FIG. 2, but that other components may be needed to control and manage the overall operation of the bike computer.

In the example embodiment, the wind sensor 22 is integrated into the bike computer 12. In other embodiments, the wind sensor 22 may be external to the bike computer 12 and interfaced thereto via a wired or wireless data connection. In any case, the wind sensor 22 operates to measure the air speed relative to the rider of the bicycle. For further details regarding an exemplary wind sensor, reference may be had to the Powerpod V5 manufactured by Velocomp. Other suitable wind sensors and anemometers are readily known in the art.

In an exemplary embodiment, the controller 28 is implemented as a microcontroller. It should be understood that the logic for the control of bike computer by controller 28 can be implemented in hardware logic, software logic, or a combination of hardware and software logic. In this regard, controller 28 can be or can include any of a digital signal processor (DSP), microprocessor, microcontroller, or other programmable device which are programmed with software implementing the above described methods. It should be understood that alternatively the controller 28 is or includes other logic devices, such as a Field Programmable Gate Array (FPGA), a complex programmable logic device (CPLD), or application specific integrated circuit (ASIC). When it is stated that controller 28 performs a function or is configured to perform a function, it should be understood that controller 28 is configured to do so with appropriate logic (such as in software, logic devices, or a combination thereof).

In some embodiments, the bike computer 12 is interfaced with a speed sensor 23. The speed sensor 23 operates to measure speed of the bicycle relative to the ground. For example, the speed sensor may be configured to measure the rotational speed of a wheel of the bicycle. Suitable speed sensors are readily known in the art.

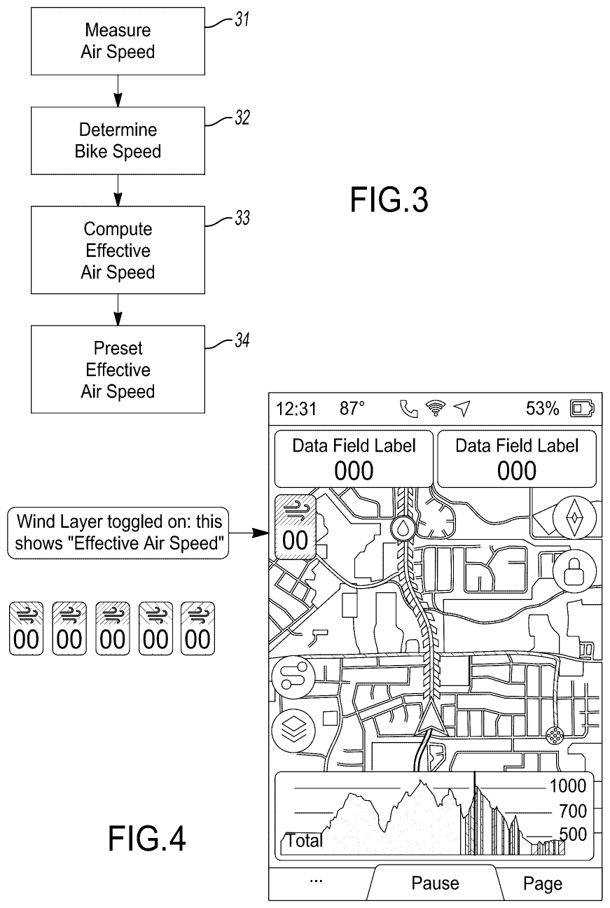

Effective wind speed is one wind metric of interest to the rider of the bicycle. An improved technique for displaying effective wind speed to a rider of a bicycle is shown in FIG. 3. To do so, the air speed relative to the rider of the bicycle is measure at 31, for example by the wind sensor 22 attached to the bicycle. Again, the wind sensor 22 may be integrated into the bike computer 12 or may be disposed external to but interfaced with the bike computer 12.

Next, the speed of the bicycle relative to the ground is determined at 32 by the controller 28 of the bike computer 12. In one example, the speed of the bicycle is received by the controller 28 as an input from the speed sensor 23. In another example, the speed of the bicycle is determined using input from the GPS module 24. For example, speed of the bicycle can be derived from the distance between two GPS locations and the time it took to traverse the distance between the two GPS locations. Other techniques for determining the speed of the bicycle also fall within the broader aspects of this disclosure.

Effective air speed experienced by the rider is computed at 33 based on the air speed and the speed of the bicycle. More specifically, effective air speed, V_{wind}, is computed by subtracting the speed of the bicycle, V_{bike}, from the air speed, Vₐᵢᵣ. The effective air speed is then presented on the display device of the bike computer to the rider as indicated at 34. The effective air speed is preferably presented along with an indicia indicating whether the air is assisting (i.e., tail wind) or hindering (i.e., head wind) the motion of the bicycle.

FIG. 4 illustrates an example user interface for a bike computer. In this example, the rider's route is shown on a map and an elevation profile is overlayed on the bottom of the map. Of note, a numeric value for the effective air speed is shown in a box 41 overlayed on the left side of the map. The color of the numeric value (or the box containing the numeric value) is an indicia of whether the air is assisting or hindering the motion of the bicycle. For example, green is used to indicate a tail wind and red is used to indicate a head wind. Blue may be used to indicate that the air is neutral (i.e., neither assisting nor hindering the rider). In other examples, different shades of green may be used to signify magnitude or strength of the tail wind and different shades of red may be used to signify magnitude or strength of head wind. These colors are merely illustrative and other color schemes may be employed.

Moreover, other types of indicia may be used to indicate whether the air is assisting or hindering the rider. In another example, a head wind is signified by an downward arrow and a tail wind is signified by an upward arrow. In other embodiments, a head wind may be indicated by flashing the numeric value of the effective air speed, such that the frequency of the flashing correlates to the magnitude of the head wind. In yet another example, the indicia may be audible, such as beeping. Other types of indicia are also contemplated by this disclosure.

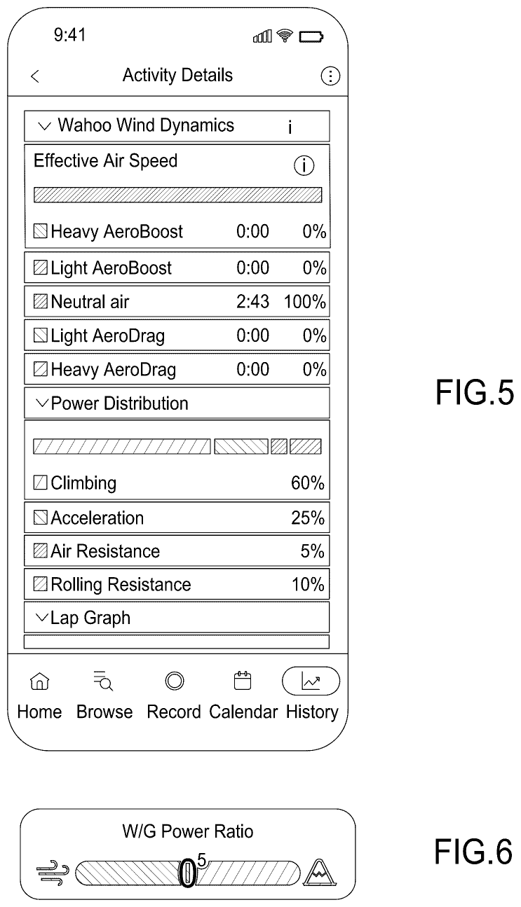

Upon concluding a ride, different metrics summarizing the ride may be displayed on the display of the bike computer. FIG. 5 illustrates another example user interface on a bike computer. In this example, the duration of the ride is partitioned into five categories: heavy tail wind, light tail wind, neutral wind, light head wind and heavy head wind. For each category, the duration of the ride spent in the category along with the percent of the total duration is shown. A summary of the power distribution may also be shown. In this example, power distribution is divided amongst how much of the rider's power was used to overcome i) gravity (climbing), ii) inertial (acceleration), iii) rolling resistance, and iv) air resistance. Other categories are also contemplated by this disclosure.

During or after a ride, other wind derived metrics may also be computed by and displayed on the bike computer. For example, the wind adjusted speed, V_{wa}, is a metric the indicates the theoretical rider speed over ground had the rider experienced no (zero) effective wind. In an example embodiment, the wind adjusted speed is calculated as follows.

The wind adjusted speed metric computes the hypothetical ground speed V_{WA} the rider would have been riding if there were no headwind (V_{wind}=0). This metric is derived from the equations that compute the rider's power output given environmental conditions

$$P = ( {F}_{air} ( {v}_{bike} + {v}_{wind} ) + {F}_{rolling} + {F}_{grade} + {F}_{acceleration} ) * {v}_{bike}$$

$$with$$

$${F}_{air} ( v ) = \frac{1}{2} * ρ * {C}_{D} A * {v}^{2}$$

$${F}_{grade} = 9.8067 * sin ( arctan ( {grade}_{\%} ) ) * W$$

If one assumes the rider's acceleration to be 0, this means that

$$( {F}_{air} ( {v}_{bike} + {v}_{wind} ) + {F}_{rolling} + {F}_{grade} ) * {v}_{bike} = ( {F}_{air} ( {v}_{WA} ) + {F}_{rolling} + {F}_{grade} ) * {v}_{WA} ⇔ {F}_{air} ( {v}_{bike} + {v}_{hw} ) * {v}_{bike} + {F}_{rolling} * {v}_{bike} + {F}_{grade} * {v}_{bike} = {F}_{air} ( {v}_{WA} ) * {v}_{WA} + {F}_{rolling} * {v}_{WA} + {F}_{grade} * {v}_{WA}$$

To reduce numerical complexity, one can approximate v_{WA} to the measured rider speed vₜᵣᵤₑ for the rolling resistance and grade components, assuming the slightly higher speed does not require these components to require higher power.

$${F}_{air} ( {v}_{bike} + {v}_{wind} ) * {v}_{bike} + {F}_{rolling} * {v}_{bike} + {F}_{grade} * {v}_{bike} = {F}_{air} ( {v}_{WA} ) * {v}_{WA} + {F}_{rolling} * {v}_{bike} + {F}_{grade} * {v}_{bike} ⇔ {F}_{air} ( {v}_{bike} + {v}_{wind} ) * {v}_{bike} = {F}_{air} ( {v}_{WA} ) * {v}_{WA} ⇔ \frac{1}{2} * ρ * {C}_{D} A * {( {v}_{bike} + {v}_{wind} )}^{2} * {v}_{bike} = \frac{1}{2} * ρ * {C}_{D} A * {( {v}_{WA} + 0 )}^{2} * {v}_{WA} ⇔ {( {v}_{bike} + {v}_{wind} )}^{2} * {v}_{bike} = {( {v}_{WA} )}^{3} ⇔ {v}_{WA} = \sqrt[3]{{( {v}_{bike} + {v}_{wind} )}^{2} * {v}_{bike}}$$

Wind adjusted grade is another wind derived metric. The wind adjusted grade metric computes the hypothetical grade that would result in the same resistive force from gravity as the current actual aerodynamic drag from effective wind. In other words, if you were to replace the head/tail wind with a climb/descent. This metric is derived from the equations that compute the rider's power output given environmental conditions

$$P = ( {F}_{air} ( {v}_{bike} + {v}_{wind} ) + {F}_{rolling} + {F}_{grade} + {F}_{acceleration} ) * {v}_{bike}$$

$$with$$

$${F}_{air} ( v ) = \frac{1}{2} * ρ * {C}_{D} A * {v}^{2}$$

$${F}_{grade} = 9.8067 * sin ( arctan ( {grade}_{\%} ) ) * W$$

or with small angle approximation

$${F}_{grade} = 9.8067 * grade \% * W$$

If one assumes the rider's acceleration to be 0, this means that

$$( {F}_{air} ( {v}_{bike} + {v}_{wind} ) + {F}_{rolling} + {F}_{grade} ( {grade}_{true} ) ) * v = ( {F}_{air} ( v ) + {F}_{rolling} + {F}_{grade} ( {grade}_{WA} ) * v ⇔ {F}_{air} ( {v}_{bike} + {v}_{wind} ) + {F}_{grade} ( {grade}_{true} ) ) = {F}_{air} ( v ) + {F}_{grade} ( {grade}_{WA} ) ⇔ \frac{1}{2} * ρ * {C}_{D} A * {( {v}_{bike} + {v}_{wind} )}^{2} + 9.8067 * {grade}_{true} * W = \frac{1}{2} * ρ * {C}_{D} A * {v}^{2} + 9.8067 * {grade}_{WA} * W ⇔ \frac{1}{2} * ρ * {C}_{D} A * {( {v}_{bike} + {v}_{wind} )}^{2} - \frac{1}{2} * ρ * {C}_{D} A * {v}^{2} + 9.8067 * {grade}_{true} * W = 9.8067 * {grade}_{WA} * W ⇔ \frac{1}{2} * ρ * {C}_{D} A * ( {( {v}_{bike} + {v}_{wind} )}^{2} - {v}^{2} ) + 9.8067 * {grade}_{true} * W = 9.8067 * {grade}_{WA} * W ⇔ {grade}_{WA} = \frac{\frac{1}{2} * ρ * {C}_{D} A * ( {( {v}_{bike} + {v}_{wind} )}^{2} - {v}^{2} ) + 9.8067 * {grade}_{true} * W}{9.8067 * W}$$

Lastly, a grade/wind power ratio can be computed for a given ride as seen in FIG. 6. The grade/wind power ratio indicates how much power is going to overcome grade versus the power required to overcome aerodynamic drag from the wind relative to the rider. This metric is defined as F_{grade}/(F_{grade}+Fₐᵢᵣ). This ratio will be zero for a user riding on a flat surface (no grade) and close to 1 for a user going up a steep hill. By definition the value is 0.5 if the bike is not moving.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method for displaying wind metrics to a rider of a bicycle, comprising:
measuring, by a wind sensor, air speed relative to the rider of the bicycle, where the wind sensor is attached to the bicycle;
determining, by a computer processor, speed of the bicycle relative to the ground, where the wind sensor is in data communication with the computer processor;
computing, by the computer processor, effective air speed experienced by the rider by subtracting the speed of the bicycle from the air speed; and
presenting, by the computer processor, the effective air speed on a display device to the rider, where the effective air speed includes an indicia of whether the air is assisting or hindering the motion of the bicycle.

2. The method of claim 1 wherein the effective air speed is a numeric value and color of the numeric value is the indicia of whether the air is assisting or hindering the motion of the bicycle.

3. The method of claim 2 further comprises displaying the numeric value for the effective air speed in green to indicate a tail wind and display the numeric value for the effective air speed in red to indicate a head wind.

4. The method of claim 1 wherein presenting the effective air speed further comprises dynamically updating the effective air speed displayed on the display device while the bicycle is moving.

5. The method of claim 1 wherein the speed of the bicycle is determined using a speed sensor configured to measure rotational speed of a wheel of the bicycle.

6. The method of claim 1 wherein the speed of the bicycle is determined using input from a GPS module interfaced with the computer processor.

7. A non-transitory computer-readable medium having computer-executable instructions that, upon execution of the instructions by a processor of a computer, cause the computer to:
receive, from a wind sensor, air speed relative to the rider of the bicycle, where the wind sensor is attached to a bicycle;
determine speed of the bicycle relative to the ground;
compute effective air speed experienced by the rider by subtracting the speed of the bicycle from the air speed; and
present the effective air speed on a display device, where the effective air speed includes an indicia of whether the air is assisting or hindering the motion of the bicycle.

8. The non-transitory computer-readable medium of claim 7 wherein the effective air speed is a numeric value and color of the numeric value is the indicia of whether the air is assisting or hindering the motion of the bicycle.

9. The non-transitory computer-readable medium of claim 8 wherein the computer executable instructions cause the computer to display the numeric value for the effective air speed in green to indicate a tail wind and display the numeric value for the effective air speed in red to indicate a head wind.

10. The non-transitory computer-readable medium of claim 7 wherein the computer executable instructions cause the computer to dynamically update the effective air speed displayed on the display device while the bicycle is moving.

11. The non-transitory computer-readable medium of claim 7 wherein the speed of the bicycle is determined using a speed sensor configured to measure rotational speed of a wheel of the bicycle.

12. The non-transitory computer-readable medium of claim 7 wherein the speed of the bicycle is determined using input from a GPS module interfaced with the computer processor

13. A system for displaying wind metrics to a rider of a bicycle, comprising:
a wind sensor attached to the bicycle and configured to measure air speed relative to the rider of the bicycle;
a bike computer in data communication with the wind sensor, wherein the bike computer is configured to determine speed of the bicycle relative to the ground and computer an effective air speed experienced by the rider by subtracting the speed of the bicycle from the air speed; and
a display device interfaced with the bike computer and configured to present the effective air speed to the rider, where the effective air speed includes an indicia of whether the air is assisting or hindering the motion of the bicycle.

14. The system of claim 13 wherein the effective air speed is a numeric value and color of the numeric value is the indicia of whether the air is assisting or hindering the motion of the bicycle.

15. The system of claim 14 wherein the numeric value for the effective air speed is displayed green to indicate a tail wind and the numeric value for the effective air speed is displayed in red to indicate a head wind.

16. The system of claim 13 wherein the effective air speed displayed on the display device is updated while the bicycle is moving.
